(19) United States
(12) Patent Application Publication
(10) Pub. No.: US 2026/0019347 A1
(43) Pub. Date: Jan. 15, 2026

(54) EDGE PROCESSING PIPELINES BASED ON APPLICATION FLOW REQUIREMENTS

(71) Applicant: Samsung Electronics Co., Ltd., Suwon-si (KR)

(72) Inventor: Prakash Reddy Kolan, Plano, TX (US)

(21) Appl. No.: 19/246,495

(22) Filed: Jun. 23, 2025

Related U.S. Application Data
(60) Provisional application No. 63/669,973, filed on Jul. 11, 2024.

(51) Int. Cl. H04L 41/5019; H04L 41/0806

(52) U.S. Cl. CPC H04L 41/5019; H04L 41/0806

(57) ABSTRACT

An apparatus includes a transceiver configured to receive, from a service provider, a service configuration associated with one or more application flows. The apparatus also includes a processor operably coupled to the transceiver. The processor is configured to select, for each of the application flows, one or more edge application servers (EASs) and one or more edge networks for processing a respective application flow based on the service configuration, and provision the selected one or more edge application servers in corresponding edge networks.

### CROSS-REFERENCE TO RELATED APPLICATION AND CLAIM OF PRIORITY

This application claims priority under 35 U.S.C. § 119(e) to U.S. Provisional Patent Application No. 63/669,973 filed on Jul. 11, 2024. The above-identified provisional patent application is hereby incorporated by reference in its entirety.

### TECHNICAL FIELD

This disclosure relates generally to wireless networks. More specifically, this disclosure relates to edge processing pipelines based on application flow requirements.

### BACKGROUND

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included in a given device is increasing. Even with the increase of processing power, portable electronic devices often struggle to provide the processing capabilities to handle new services and applications, as newer services and applications often require more resources than are included in a portable electronic device. Improved methods and apparatuses for configuring and deploying media processing in the network are desirable.

Cloud media processing is gaining traction where media processing workloads are setup in the network (e.g., cloud) to take advantage of benefits offered by the cloud such as (theoretically) infinite compute capacity, auto-scaling based on demand, and on-demand processing. An end user client can request a network media processing provider for provisioning and configuration of media processing functions.

### SUMMARY

This disclosure provides apparatuses and methods for edge processing pipelines based on application flow requirements.

In one embodiment, an apparatus is provided. The apparatus includes a transceiver configured to receive, from a service provider, a service configuration associated with one or more application flows. The apparatus also includes a processor operably coupled to the transceiver. The processor is configured to select, for each of the application flows, one or more edge application servers (EASs) and one or more edge networks for processing a respective application flow based on the service configuration, and provision the selected one or more EASs in corresponding edge networks.

In another embodiment, a method is provided. The method includes receiving, from a service provider, a service configuration associated with one or more application flows. The method also includes selecting, for each of the application flows, one or more EASs and one or more edge networks for processing a respective application flow based on the service configuration, and provisioning the selected one or more EASs in corresponding edge networks.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIGS. 2 and 3 illustrate example electronic devices according to embodiments of the present disclosure;

FIG. 4 illustrates an example of ASP configuration of service parameters according to embodiments of the present disclosure;

FIG. 5 illustrates an example of configuration of service application flows according to embodiments of the present disclosure;

FIG. 6 illustrates an example of QoS configuration for different application flows according to embodiments of the present disclosure;

FIG. 7 illustrates an example of ASP configuration of service parameters including a list of edge networks according to embodiments of the present disclosure;

FIG. 8 illustrates an example method for associating processing of specific application flows in specific edge application servers in specific edge networks according to embodiments of the present disclosure;

FIG. 9 illustrates an example of ASP configuration of service parameters including an edge pipeline sequence/structure according to embodiments of the present disclosure;

FIGS. 10A-10C illustrate example textual representations of edge pipelines in an edge deployment according to embodiments of the present disclosure;

FIG. 11 illustrates an example procedure for edge application service reorganization according to embodiments of the present disclosure;

FIG. 12 illustrates an example method for adjusting QoS/policy for a service using flow importance according to embodiments of the present disclosure;

FIG. 13 illustrates an example of ASP configuration of service parameters including application flow edge network association according to embodiments of the present disclosure;

FIG. 14 illustrates an example method for edge pipeline construction according to embodiments of the present disclosure; and

FIG. 15 illustrates an example method for provisioning EASs based on application flow requirements according to embodiments of the present disclosure.

### DETAILED DESCRIPTION

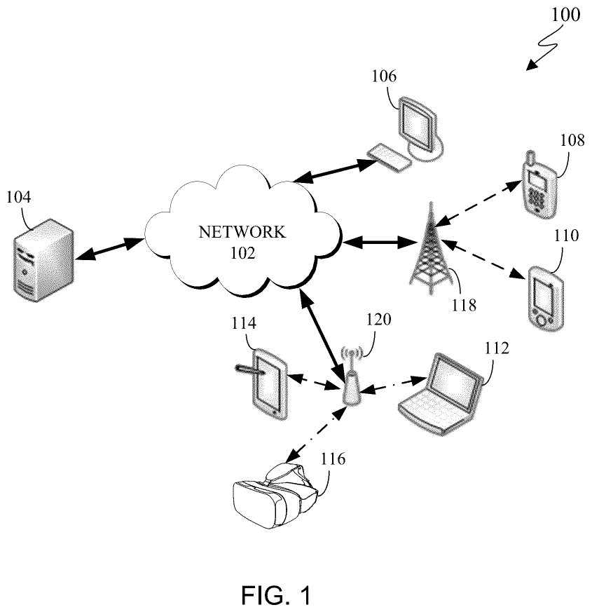

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. A client device may also be referred to herein as a user equipment (UE). Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations, eNodeBs (eNBs), or gNodeBs (gNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in the present disclosure can be used, these features could be used in any other suitable system.

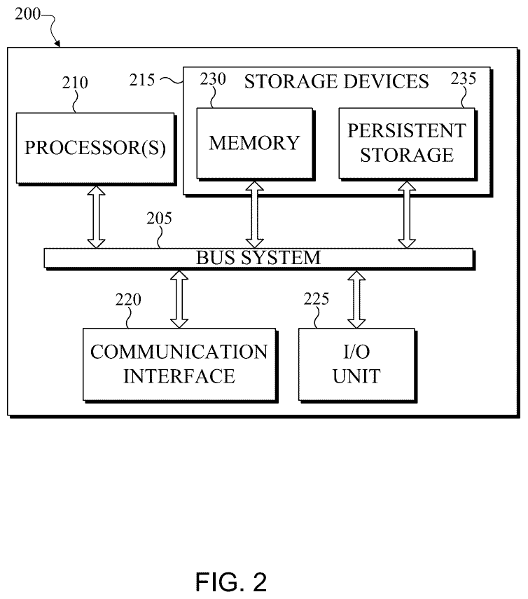

FIGS. 2 and 3 illustrate example electronic devices according to embodiments of the present disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue [RGB] sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

Wireless networks support protocol data unit (PDU) set based differentiated handling. As described herein, a PDU set refers to one or more PDUs carrying the payload of one unit of information generated at the application level (e.g., frame[s] or video slice[s] etc., for eXtended Reality [XR] Services). All the PDUs of a PDU set may be transmitted within the same quality of service (QoS) flow. The QoS flow may be enabled with PDU set based QoS handling, and for these QoS Flows, PDU set QoS parameters may be determined by a policy control function (PCF) and provided by a session management function (SMF) to a next generation (NG)-radio access network (RAN) as part of the QoS profile. As described herein, a PDU set may be associated with the following three QoS parameters:
1. PDU set delay budget (PSDB): The PDU set delay budget (PSDB) defines an upper bound for the delay that a PDU set may experience for the transfer between the UE and the N6 termination point at the user plane function (UPF), (i.e., the duration between the reception time of the first PDU [at the N6 termination point for downlink (DL) or the UE for uplink (UL)] and the time when all PDUs of a PDU Set have been successfully received [at the UE for DL or N6 termination point for UL]). The DL PSDB applies to the DL PDU Set received by the PDU session anchor (PSA) UPF over the N6 interface, and the UL PSDB applies to the UL PDU Set sent by the UE.
2. PDU set error rate (PSER): The PDU set error rate (PSER) defines an upper bound for the rate of PDU sets that have been processed by the sender of a link layer protocol (e.g., radio link control [RLC] in a radio access network [RAN] of a 3GPP access) but that are not successfully delivered by the corresponding receiver to the upper layer (e.g., packet data convergence protocol [PDCP] in a RAN of a 3GPP access). Thus, the PSER defines an upper bound for a rate of non-congestion related PDU set losses. The purpose of the PSER is to allow for appropriate link layer protocol configurations (e.g., RLC and hybrid automatic repeat request [HARQ] in a RAN of a 3GPP access).
3. PDU Set Integrated Handling Information (PSIHI): The PDU Set Integrated Handling Information (PSIHI) indicates whether all PDUs of the PDU set are used for the usage of the PDU set by the application layer in the receiver side. PSIHI is an optional parameter. A QoS Flow is associated with at most one PSIHI value per direction.

The above PDU set parameters may be delivered by the PCF through the SMF to the radio network entities of the NG-RAN. When the NG-RAN receives the PDU set parameters from the PCF through the SMF, the NG-RAN may apply the requested QoS to the identified QoS flows with PDU set content. The flows with PDU set content are originally identified at the data processing function—the User Plane Function (UPF) and marked accordingly before being forwarded to the NG-RAN. For downlink (DL), when the radio network entities (or the NG-RAN system in general) receive packets marked as having PDU set content, the radio network entities apply the received PDU set QoS parameters from the PCF through the SMF. Similarly, for uplink (UL) direction flows, the NG-RAN applies the requested uplink PDU set QoS parameters.

Some key issues exist for edge computing in 5G networks. One such key issue is edge computing traffic routing between the local part of a data network (DN) and the central part of the DN. For example, when edge computing is deployed for 5G services (i.e., edge application servers [EASs] are deployed in the local DN to assist/replace remote application server processing):
UL traffic related to an application is first routed over edge computing (EC) to one or more application server(s) for local-processing, and then further forwarded to one or more remote application Server(s) in the central part of the DN.
DL traffic related to an application is first routed over the central part of the DN for processing, then forwarded to one or more application server(s) in the local EC for local-processing and finally provided to the UE.

For the above cases, the following issues are being considered:
How the 5G core (5GC) is aware that application traffic is requested to be processed at different locations, and in what order, including how to distinguish the UL/DL traffic traversing through the PDU session anchor (PSA);
How to guarantee QoS for traffic transmission between the local and central parts of a DN;
Whether and what information is to be provided to make the final destination (e.g., a UE, a server in the central part of the DN) aware of the traffic being processed by the edge hosting environment.

Various embodiments of the present disclosure provide methods and procedures for addressing the above key issues, and also consider the impact of PDU set QoS flow processing due to edge computing.

Next generation services are being planned for deployment in 5G networks. These are complex services having considerable QoS and quality of experience (QoE) considerations. Additionally, edge computing is gaining traction, wherein edge application services are being deployed close to the end user, usually to reduce the end-to-end latency and for a faster response. Some of the services include interactive and personalized services that require faster response time, extreme low latency, and very high reliability.

Edge computing has been in deployment for some time now, starting with 4G LTE, and is being designed and developed for use with newer 5G networks. With edge computing, a network operator may provision edge application services in one or more edge networks to assist the UEs and application providers to realize the application requirements of planned services. The decisions for setting up edge application services are currently based on overall service requirements. However, these decisions do not take into consideration application requirements of individual application flows, which can present an issue if the application flows have conflicting application requirements. Various embodiments of the present disclosure provide methods and procedures for edge network deployment based on application flow requirements.

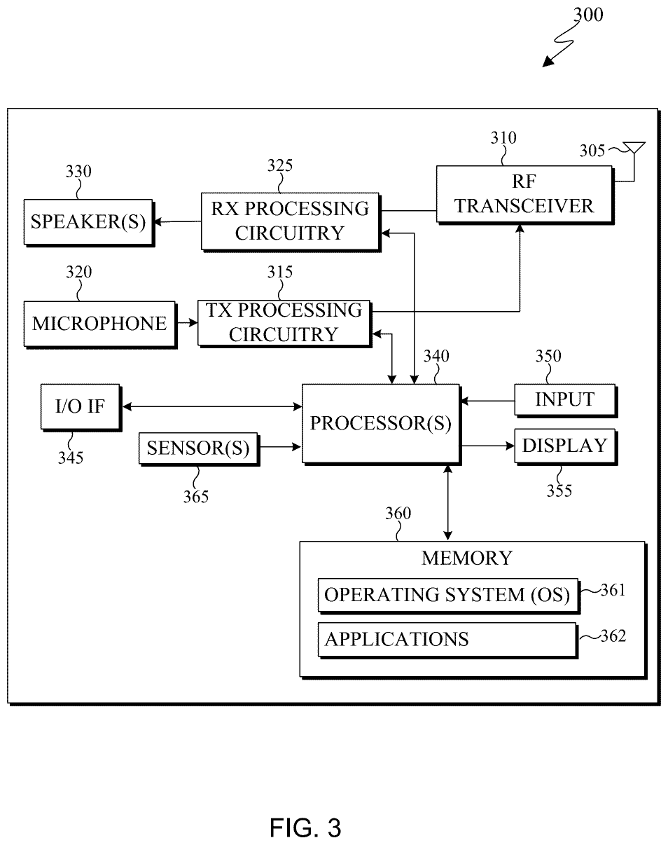

In some embodiments, methods and procedures for 5G media streaming may include service provisioning between a network entity in an operator network and an application service provider (ASP) similar as shown in FIG. 4.

FIG. 4 illustrates an example 400 of ASP configuration of service parameters according to embodiments of the present disclosure. The embodiment of ASP configuration of service parameters of FIG. 4 is for illustration only. Different embodiments of ASP configuration of service parameters could be used without departing from the scope of this disclosure.

In the example of FIG. 4, an M1 interface 406 is provided between a network entity (i.e., application function [AF] 408. As described herein, an AF may also be referred to as an application server) in the operator network 404 and ASP 402. The M1 interface 406 allows specification of service details related to content ingestion into the operator network, content preparation before distribution to ASP subscribers through the operator network 404, security considerations, QoS and policy provisioning, reporting of quality and service consumption metrics, and network assistance for assisting UEs 430 in optimizing their performance.

The ASP 402 is aware of the type of content being ingested into the operator network 404 using an M2 interface (not shown). This means that the ASP 402 has complete visibility into the traffic characteristics of the content being ingested into the operator network 404. As a result, the ASP 402 may provide additional information to the AF 408 in the operator network 404 about the content and requested edge networking support for facilitating the delivery of service content to operator users that are subscribers of the ASP 402. The following information may be provided by the ASP 402 to the AF 408 during a service provisioning stage of the service, for example using the M1 interface:
Content specification: Informs the AF 408 about the type of content being ingested into the operator network 404 for distribution to operator network subscribers who would like to access the service provided by the ASP 402. The information may include the following details:
   Flow descriptor information: Descriptor specifying details about application flows as part of this service. Such information may be provided for each application flow among all the application flows of the service.
Edge network deployment information: The following information may be provided to the AF 408:
   List of edge networks (e.g., edge networks 416 [edge hosting environment A] and 418 [edge hosting environment B]) where service instances are to be setup for processing or forwarding the content.
   Edge-pipeline: A pipeline of edge networks to use for processing/forwarding the content. The details of edge pipeline are in accordance with the information described later in the disclosure.
   Edge-application-service-reorganization: Indicates whether the application function in the operator network may re-organize edge application services among the different edge networks provisioned above in the edge-pipeline to provide QoS and QoE to the end users that are receiving the edge processed service. The procedure for edge-application-service-reorganization is in accordance with the details described later in the disclosure.
   Differential-edge-service-instance-deployment: Indicates whether the operator network is to provision different types of edge service application instances for different types of application flows for which the content specification is provided above. Details of this deployment are in accordance with the information described later in the disclosure. Such information may be provided separately for each of the application flows.

The AF 408 may interact with other within operator network 404, such one or more network control/management entities 410 (such as a PCF, SMF, etc.) and gNB 428.

Although FIG. 4 illustrates one example 400 of ASP configuration of service parameters, various changes may be made to FIG. 4. For example, various changes to number of edge networks could be made, AF 408 could be replaced with a different network entity, etc. according to particular needs.

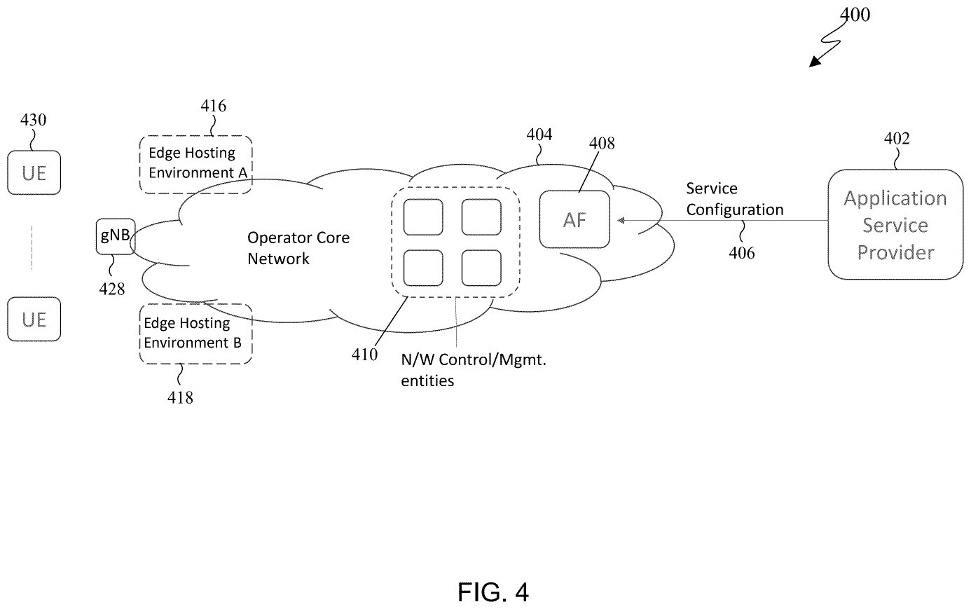

The discussion above regarding FIG. 4 describes service provisioning configuration from the ASP 402 to the AF 408 in the operator network 404 at a high level. Additional details about service provisioning information configuration are discussed below with respect to FIG. 5.

FIG. 5 illustrates an example 500 of configuration of service application flows according to embodiments of the present disclosure. The embodiment of configuration of service application flows of FIG. 5 is for illustration only. Different embodiments of configuration of service application flows could be used without departing from the scope of this disclosure.

FIG. 5 shows a service configuration 506 of all application flows 1 through N in the service by the ASP 402 at the AF 408 in the operator network 404. For each of the application flows 1 through N, the following details may be provisioned by the ASP 402 at the AF 408 to manage the application/service:
Content Id: An identifier for content that is unique to this service (i.e., a different application flow is represented using a different content identifier)
Content type: Type of content (e.g., audio, video, timed-text etc.)
PDU set formatted content: Boolean variable indicating whether the flow includes PDU Set type content and uses related processing in the operator network.
QoS specification information: Requested QoS for the corresponding application flow. The requested QoS is either based on 5QI information, PDU Set QoS information, or an M1QoSSpecification. Based on this specification information, the AF 408 may apply the requested QoS behavior to the corresponding application flow when it is delivered to the end user.
Edge-network-processing-requirement: Indicates whether the ASP intends that the network operator provision edge deployments to process or forward the corresponding application flow

For a given application flow, if the ASP 402 indicates that the constituent media in the application flow contains PDU set formatted content, the AF 408 may assist other network functions such as a PCF and SMF to apply PDU set based QoS as described herein. The AF 408 informs the PCF that for this flow, PDU set based QoS is used, and that the PCF is to inform the NG-RAN about applying PDU Set based QoS handling procedures. The QoS information for handling the application flows is extracted from the QoS specification information provisioned by the ASP 402.

For a given application flow, if the ASP 402 indicates that the application flow utilizes edge network processing by including the “edge-network-processing-requirement” indicator, the operator network 404 is to setup edge service application instances to process or forward the content in the corresponding application flow as described later herein.

Although FIG. 5 illustrates one example 500 of configuration of service application flows, various changes may be made to FIG. 5. For example, various changes to the number of flows could be made, etc. according to particular needs.

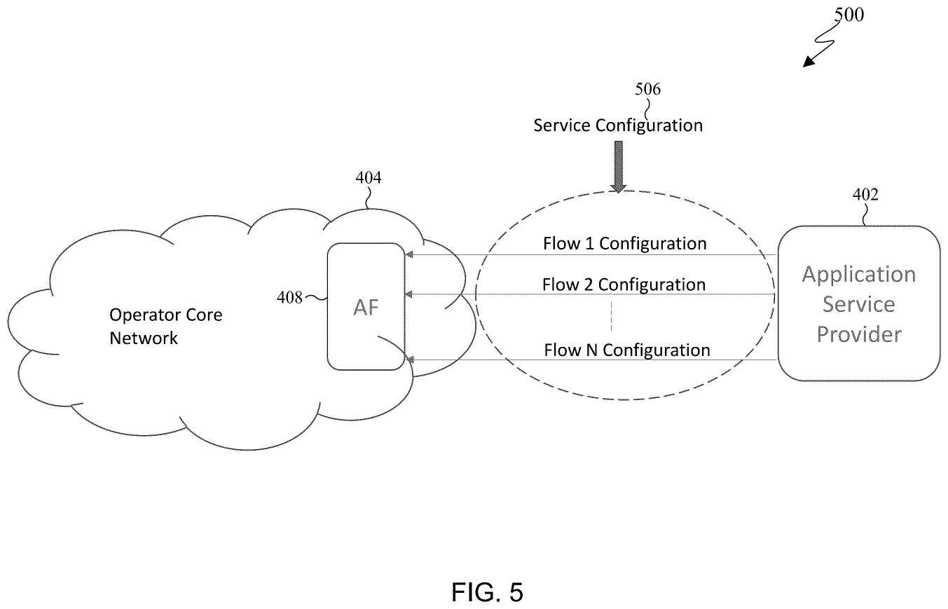

When an application service provider provides the facilities to configure QoS for individual application flows, it is possible that different application flows in a service may have different QoS requirements. Further, each of those application flows may have QoS requirements based on different specifications as shown in FIG. 6

FIG. 6 illustrates an example 600 of QoS configuration for different application flows according to embodiments of the present disclosure. The embodiment of QoS configuration for different application flows of FIG. 6 is for illustration only. Different embodiments of QoS configuration for different application flows could be used without departing from the scope of this disclosure.

As shown in FIG. 6, one application flow may be configured with a QoS specification based on PDU set QoS parameters, another application flow may be configured with a QoS specification based on 5QI parameters, and another application flow may be configured with a QoS specification based on M1QoSSpecification parameters. Depending on the type of QoS specification, respective procedures are implemented (for example, procedures specified in relevant standards documents).

Although FIG. 6 illustrates one example 600 of QoS configuration for different application flows, various changes may be made to FIG. 6. For example, various changes to the number of flows could be made, etc. according to particular needs.

In some embodiments, the content specification for application flows with different QoS configurations may also include an indicator for an edge-network-processing-requirement. When this indicator is present and enabled in the service configuration information, the ASP 402 intends that the network operator provision edge deployment for processing/forwarding the application flow between the UE 430 and the application server (e.g., AF 408). The type of edge processing deployment to be undertaken is provided in the higher level edge network deployment information in the service configuration information. The following description provides details about edge network deployment information, and corresponding procedures to use this information to improve the QoS and QoE of the service.

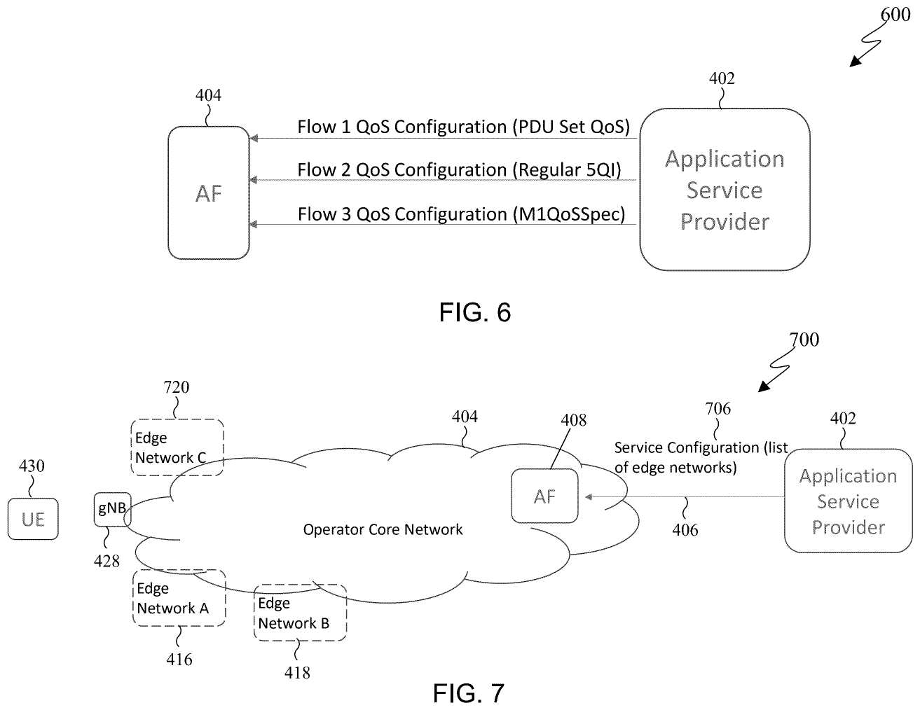

In some embodiments, it is possible that there is more than one edge network that can host the edge application servers of the application service. Usually, the ASP 402 negotiates with the operator of operator network 404 for service performance using a set of service requirements, and the operator decides to provision edge instances in an edge network close to the end user. An example procedure to setup edge application services in multiple edge networks is shown in FIG. 7.

FIG. 7 illustrates an example 700 of ASP configuration of service parameters including a list of edge networks according to embodiments of the present disclosure. The embodiment of ASP configuration of service parameters of FIG. 7 is for illustration only. Different embodiments of ASP configuration of service parameters including a list of edge networks could be used without departing from the scope of this disclosure.

As shown in FIG. 7, the ASP 402 may include the list of recommended edge networks for content processing/forwarding to the UE in service configuration 706. When the AF 408 receives this information from the ASP 402, the AF 408 interacts with policy and session management functions to setup edge resources in the provided edge network list. For example, the edge network list may include edge networks 416 (“Edge Network A”), 418 (“Edge Network B”), and 720 (“Edge Network C”).

In some embodiments, the ASP 402 may provide a preference order of the edge networks in the service configuration information of service configuration 706. When the service configuration information from the ASP 402 includes preference information about specific edge networks, the operator of operator network 404 may attempt to setup edge application resources in that preferred list of edge networks.

Alternatively, in some embodiments, the ASP 402 may provide a unique priority value for each edge network in the list of edge networks. When the service configuration information from the ASP 402 includes priority information for each edge network in the edge network list, the AF 408 requests the network operator policy and session management functions to setup edge application services in edge networks with higher priority before attempting to setup resources in the lower priority edge networks.

Although FIG. 7 illustrates one example 700 of ASP configuration of service parameters including a list of edge networks, various changes may be made to FIG. 7. For example, various changes to number of edge networks could be made, AF 408 could be replaced with a different network entity, etc. according to particular needs.

Specifications for wireless networks describe design principles and procedures for provisioning of edge resources for a media streaming sessions, and setting up the connectivity between the edge application servers, the UE, and the applications in the data network. However, these specifications do not describe the procedure for identifying the type of edge application servers for provisioning needs. Various embodiments of the present disclosure provide procedures for setting specific application instances/servers for specific application flows.

In some embodiments, one or more EASs may be associated with one or more details. For example, an EAS type, various hardware details, processor details, and all the capabilities of the EAS. In some embodiments, the EAS type and capability information of each EAS may be published to an external directory. This publishing is performed by all the edge networks that intend to offer edge computing capabilities to the network operator. When the ASP 402 determines, from the directory, the type and capabilities of EAS application servers that can be deployed in each edge network, the ASP 402, knowing the capabilities/requirements of each application flow in the multimedia service, may provide association information of a type and capability of an EAS to be used for each application flow.

The information in the service configuration 506 from the ASP 402 to the AF 408 as discussed earlier herein includes content specification information that provides details about the content that being sent to the UE 430. In some embodiments in addition to the details in the content specification, an additional field called “flow-edge-application-server-association” may be included for each application flow. In these embodiments, the value of this field is set to be the type/identifier/description of the EAS where the processing of the application flow is to take place.

In some embodiments, when the AF 408 receives service configuration information with content specification information, AF 408 checks to see whether the content specification for each application flow includes the field called “flow-edge-application-server-association”. In these embodiments, when the AF 408 determines that for an application flow, an association for a preferred EAS type or capability is provided using this field, the AF 408 interacts with other control functions (e.g., the entities 410) to setup the requested EAS (edge application server) in the appropriate edge network. Optionally, in some embodiments, the ASP 402 may also provide the edge network in which this specific edge application server is to be setup.

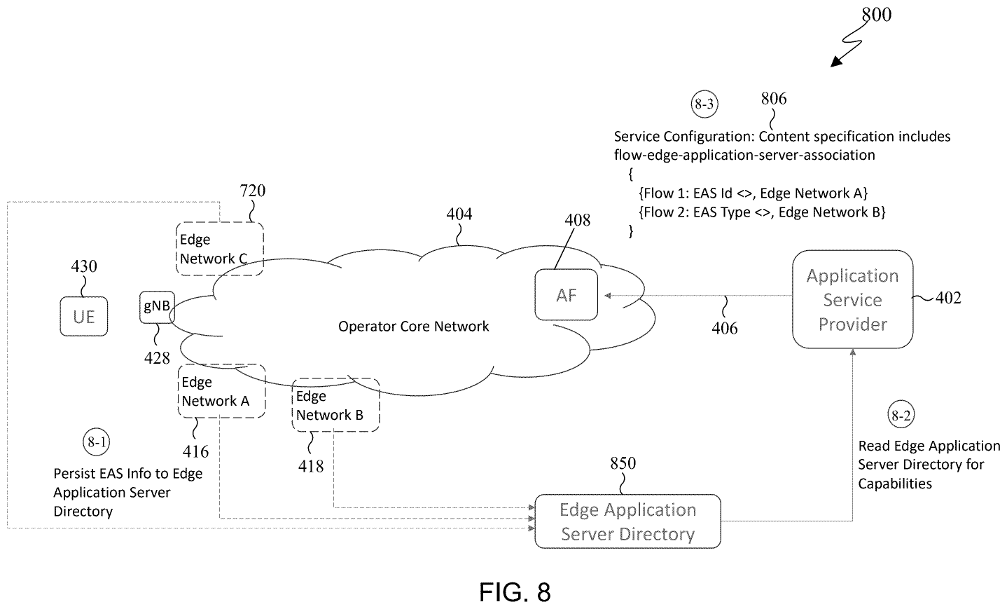

FIG. 8 illustrates an example method 800 for associating processing of specific application flows in specific edge application servers in specific edge networks according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method for associating processing of specific application flows in specific edge application servers in specific edge networks could be used without departing from the scope of this disclosure.

In the example of FIG. 8, method 800 begins at step 8-1. At step 8-1, each edge network provider (e.g., for edge networks 416, 418, and 720) persist information about all possible EASs into an external edge application server directory 805. The information about the EASs may include the EAS type, capabilities etc.

At step 8-2, ASP 402 reads the EAS information about each EAS in each edge network from edge application server directory 805. ASP 402 then associates processing of each application flow in service configuration 806 to an EAS that could provide the best alternative for processing content.

At step 8-3, ASP 402 provisions the service at the AF 408 via the service configuration 806. The service configuration information in service configuration 806 includes the content specification along with the “flow-edge-application-server-association” information as described herein.

When an application server (e.g., AF 408) receives service configuration information with flow-edge-application-server-association information, the application server performs setting of specific EAS types and capabilities in specific edge networks as described in this embodiment.

With the above differential edge service deployment option described above, it is possible for application flows with different QoS requirements to be forwarded for processing on different edge application servers. For example, application flows with PDU set QoS requirements and parameters are forwarded to a different type of edge application servers, and application flows with regular 5QI QOS requirements and parameters are forwarded to a different type of edge application servers. This allows differential treatment to different application flows.

Although FIG. 8 illustrates one example method 800 for associating processing of specific application flows in specific edge application servers in specific edge networks, various changes may be made to FIG. 8. For example, while shown as a series of steps, various steps in FIG. 8 could overlap, occur in parallel, occur in a different order, occur any number of times, be omitted, or replaced by other steps.

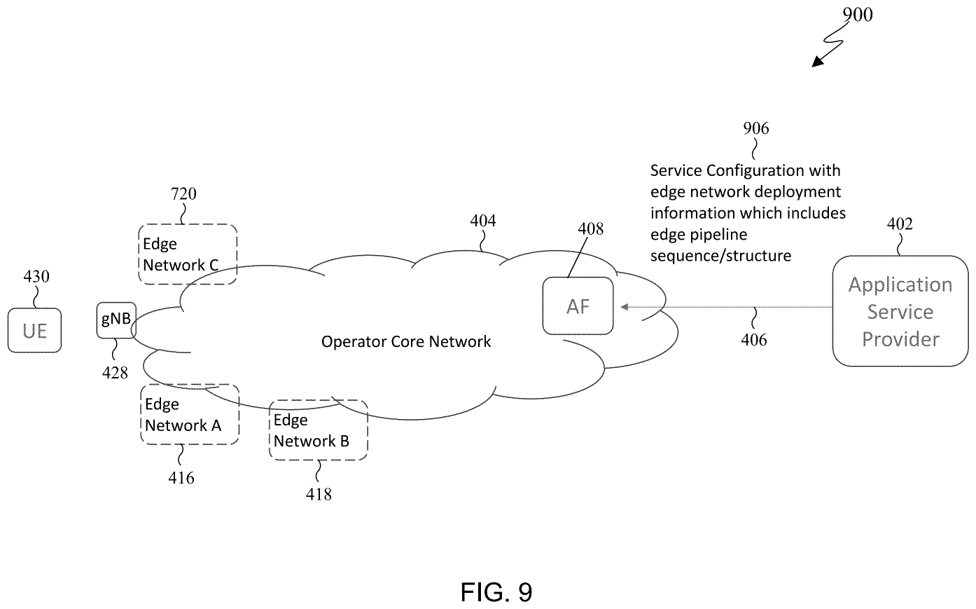

Method 800 provides for edge network provisioning for different type of application flows. However, method 800 focuses on provisioning one or more edge networks where the application services/servers are to be deployed, with no consideration on how to use them. Further, it is possible that the application flows may be processed in more than one edge network, and sometimes in a specific sequence. For example, in FIG. 8, the application flow processing may be partially performed in edge network 418 (Edge Network B), then in the remainder of the application processing may be performed in edge network 416 (Edge Network A) before forwarding the final processed application flow to UE 430. This structure, or sequence, of edge network processing may be represented using an edge pipeline. An edge pipeline is a directed acyclic graph (DAG) of nodes that represent the structure of the edge application processing deployment. In some embodiments, this graph information may be provided by the ASP 402 to the operator of operator network 404 based on information about capabilities of different edge application service instances that can be deployed in different edge networks as shown in FIG. 9. This information can be made available to the ASP 402, for example using the edge application server directory 850 as described herein.

FIG. 9 illustrates an example 900 of ASP configuration of service parameters including an edge pipeline sequence/structure according to embodiments of the present disclosure. The embodiment of ASP configuration of service parameters of FIG. 9 is for illustration only. Different embodiments of ASP configuration of service parameters including a list of edge networks could be used without departing from the scope of this disclosure.

As shown in FIG. 9, the ASP 402 may include an edge pipeline sequence/structure for content processing/forwarding to the UE in service configuration 906. When the AF 408 receives this information from the ASP 402, the AF 408 interacts with policy and session management functions to setup edge resources in the edge pipeline. For example, the edge pipeline may include edge networks 416 (“Edge Network A”), 418 (“Edge Network B”), and 720 (“Edge Network C”).

Although FIG. 9 illustrates one example 900 of ASP configuration of service parameters including an edge pipeline sequence/structure, various changes may be made to FIG. 9. For example, various changes to number of edge networks could be made, AF 408 could be replaced with a different network entity, etc. according to particular needs.

As previously described herein, an edge pipeline is represented as a DAG with a set of nodes and connections between those nodes. In some embodiments, the edge pipeline may represent using three attributes as shown below:

Nodes: <Array of Nodes in the DAG that take part in processing of application
flow>,
NodeAssociation: <Array of Node associations to Edge Networks>,
Connections: <Array of connections between Nodes>

### Where:

Nodes are the edge application servers that are capable of processing application flows. Each element of the array represents an edge application server.
NodeAssociation represents which Node (i.e., edge application server) belongs to which Edge Network. Each element of the array is of the form {Node X, Edge Network Y} which represents that the edge application server Node X belongs to Edge Network Y.
Connections represent array of links between the Nodes. Each element of the array is of the form {Node X, Node Y} which represents that there is a connection from Node X to Node Y i.e., the application flow is processed in Node X (edge application server X) and then in Node Y (edge application server Y).

The above representation is given for each of the application flows.

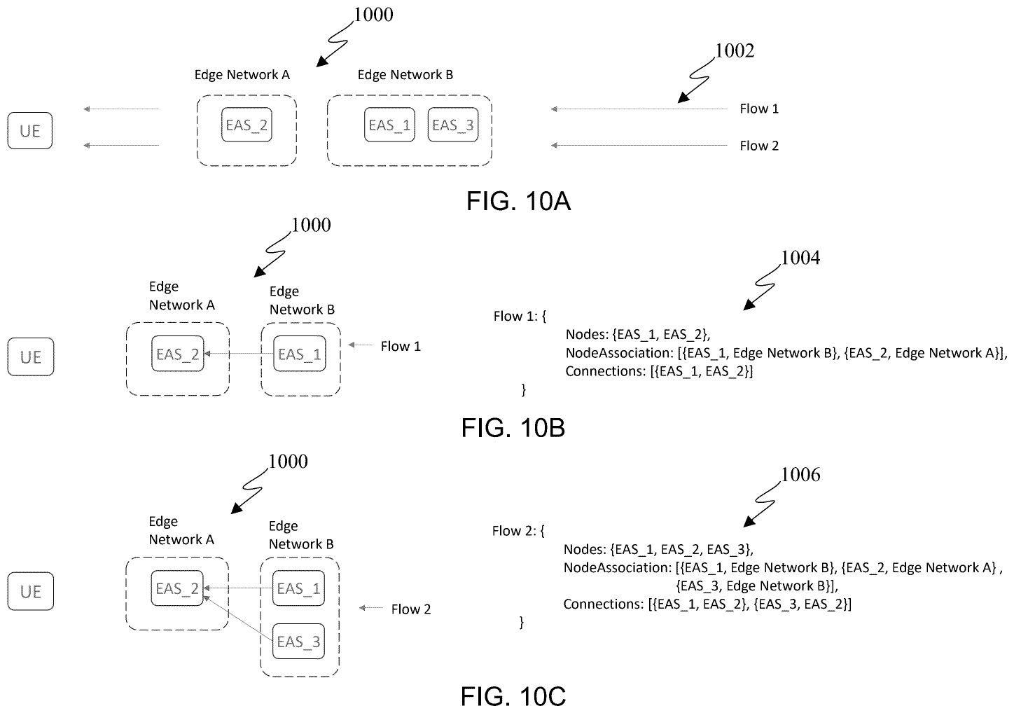

For example, if the application server intends to have processing done in two edge networks (Edge Network A and Edge Network B), then the application server may provide an edge pipeline representation as described below regarding FIGS. 10A through 10C.

FIGS. 10A-10C illustrate example textual representations of edge pipelines in an edge deployment 1000 according to embodiments of the present disclosure. The embodiments of edge pipelines of FIGS. 10A-10C are for illustration only. Different embodiments of edge pipelines could be used without departing from the scope of this disclosure.

FIGS. 10A-10C show an example edge deployment 1000 wherein there are two edge networks (Edge Network A and Edge Network B) that the ASP 402 may use for edge application processing.

In edge deployment 1000, there are also two application flows 1002 for which processing is to be performed by edge application servers in those edge networks. In the example of FIGS. 10A-C there are two edge application servers (EAS_1 and EAS_3) in Edge Network B and one edge application server (EAS_2) in Edge Network A.

FIG. 10B shows an example pipeline 1004 wherein the application server intends that traffic of application flow 1002 “Flow 1” is to be processed in edge application server EAS_1 in Edge Network B, and subsequently in edge application server EAS_2 in Edge Network A. So, in this case, the edge pipeline 1004 may be represented as below:

```
Flow 1: {
    Nodes: {EAS_1, EAS_2},
    NodeAssociation: [{EAS_1, Edge Network B}, {EAS_2, Edge
Network A}],
    Connections: [{EAS_1, EAS_2}]
  }
```

### Where:

Nodes {EAS_1, EAS_2} represents that “Flow 1” is to be processed by two edge application servers EAS_1 and EAS_2.
NodeAssociation represents that edge application server EAS_1 is in Edge Network B, and edge application server EAS_2 is in Edge Network A
Connections represent the sequence or structure of processing. In this case, processing is to be done in EAS_1 before processing in EAS_2

FIG. 10C shows an example pipeline 1006 where in the application server intends that traffic of application flow 1002 “Flow 2” is to be processed in two edge application server EAS_1 and EAS_3 in Edge Network B, and subsequently in edge application server EAS_2 in Edge Network A. So, in this case, the edge pipeline 1006 may be represented as below:

```
Flow 2: {
    Nodes: {EAS_1, EAS_2, EAS_3},
    NodeAssociation: [{EAS_1, Edge Network B}, {EAS_2, Edge
Network A} ,
        {EAS_3, Edge Network B}],
    Connections: [{EAS_1, EAS_2}, {EAS_3, EAS_2}]
  }
```

### Where:

Nodes {EAS_1, EAS_2, EAS_3} represents that “Flow 2” is to be processed by three edge application servers EAS_1, EAS_2, and EAS_3.
NodeAssociation represents that edge application server EAS_1 is in Edge Network B, edge application server EAS_2 is in Edge Network A, and edge application server EAS_3 is in Edge Network B
Connections represent the sequence or structure of processing. In this case, processing is to be done in EAS_1 and EAS_3 before processing in EAS_2.

FIG. 10C shows a parallel execution sequence (i.e., Flow 2 is processed in parallel by EAS_1 and EAS_3 before being processed in EAS_2).

Although FIGS. 10A-10C illustrate example textual representations of edge pipelines in an edge deployment, various changes may be made to FIGS. 10A-10C For example, various changes to the number of edge networks and EASs could be made, etc. according to particular needs.

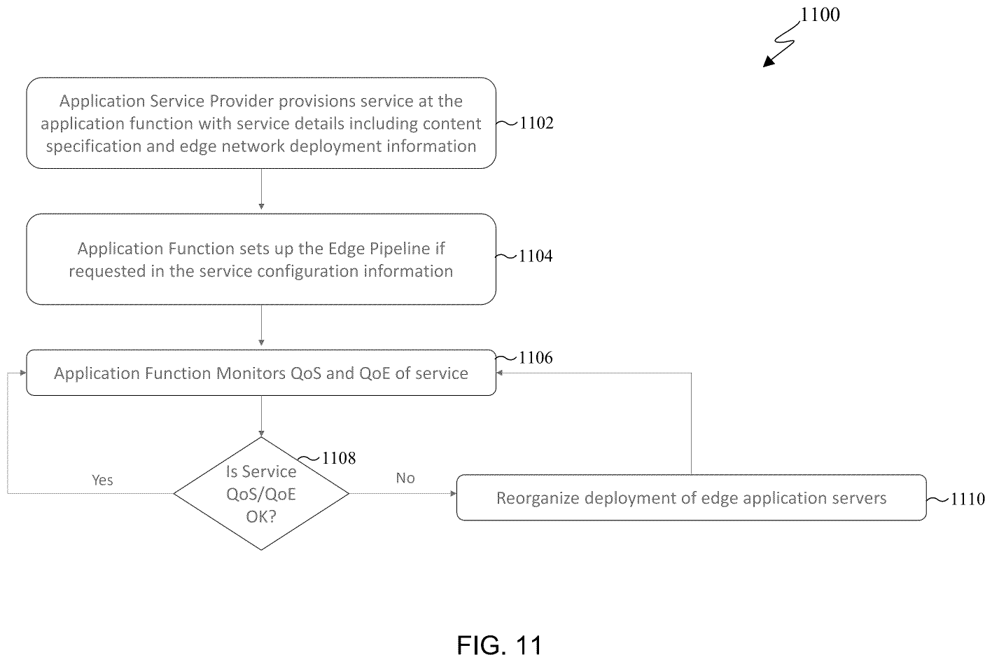

FIGS. 9 and 10A-10C relate to a method of edge pipeline construction and provisioning at the AF 408 so the operator network 404 may provision appropriate edge application servers in the correct edge networks. It is possible that the edge pipeline communicated by the application service is not optimal and doesn't provide the requested QoS/QoE to the application flows. In this case, the AF 408 may perform edge application service reorganization as shown in FIG. 11. For example, the one or more of the following reorganization tasks:
modifying the edge pipeline
relocating one or more of the edge application servers to a different location
splitting the processing functionality of one or more edge application servers, and move partial processing to a different edge application server
updating the processing functionality of one or more edge application functions
adding one or more edge application servers to the edge pipeline, and redistribute application flow traffic towards the new edge application services.

FIG. 11 illustrates an example procedure 1100 for edge application service reorganization according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for edge application service reorganization could be used without departing from the scope of this disclosure.

In the example of FIG. 11, procedure 1100 begins at step 1102. At step 1102, an application service provider (e.g., ASP 402) configures service configuration information at an application function (e.g., AF 408) and requests provisioning of the service for operator users that are the subscribers of the application service provider. The service configuration information includes the content specification and edge network deployment information as described herein.

At step 1104, the application function, upon receiving the service configuration information, sets up the requested edge pipeline as described by different procedures herein (e.g., as described regarding FIGS. 9 and 10A-10C).

At step 1106, the application function monitors the QoS and QoE of the service, for example using metrics reporting and consumption reporting procedures.

At step 1108, the application function determines whether the service QoE/QoE is okay as indicated using the service QoS/QoE metrics. If the Service QoE/QoE is okay as indicated using the service QoS/QoE metrics, the application function makes no change to the edge pipeline (i.e., the procedure returns to step 1106). Alternatively, if the QoS/QoE is suffering, the application function performs edge application service reorganization tasks as discussed herein at step 1110. After performing the reorganization tasks, the application function continues to periodically check the QoS/QoE (i.e, the procedure returns to step 1106).

Although FIG. 11 illustrates one example procedure 1100 for edge application service reorganization, various changes may be made to FIG. 11. For example, while shown as a series of steps, various steps in FIG. 11 could overlap, occur in parallel, occur in a different order, occur any number of times, be omitted, or replaced by other steps.

As discussed earlier herein, a method for applying QoS to different application flows in the service that were initially configured with different QoS specification is described with respect to FIG. 6. Various embodiments, of the present disclosure provide for a procedure wherein an application function (e.g., AF 408) may use priority information to prioritize those application flows for QoS enforcement procedures.

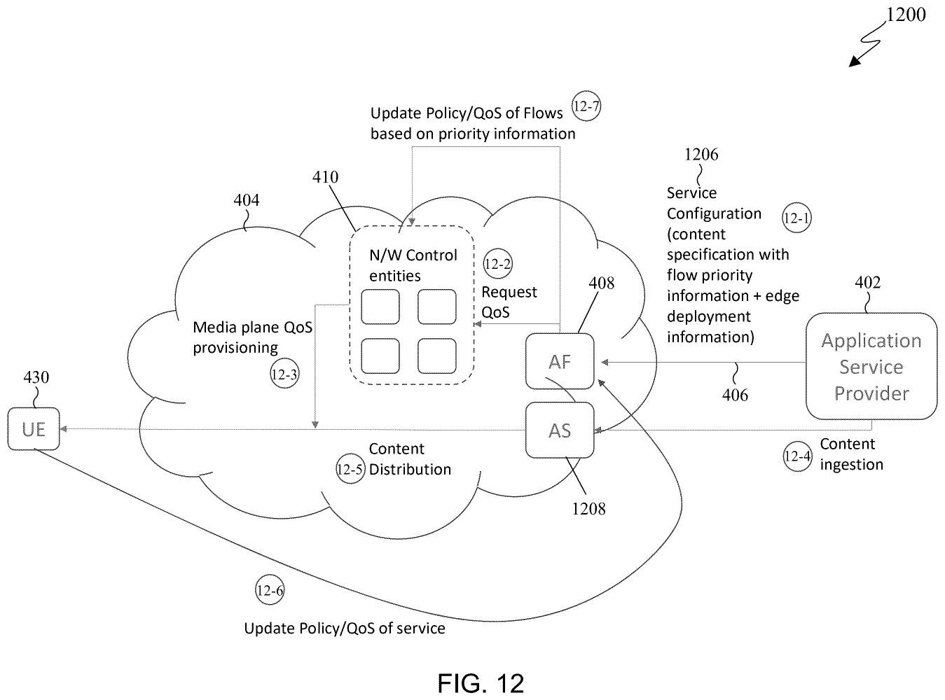

When there are application flows with different QoS requirements and specifications, the application function interacts with other control functions of the network such as PCF and SMF to facilitate QoS provisioning based on those configured QoS specifications. However, it is possible that the operator may not be able to satisfy the QoS requirements for all the application flows. It is not clear which of the application flows have to be prioritized on QoS realization. To help with this issue, the application service provider (e.g., ASP 402) may additionally configure the priority or importance of each application flow relative to other application flows in the service. In this case, when the network is tasked with choosing one or more application flows for enforcing the QoS requirements, the priority or importance information is helpful. To facilitate this behavior, the content specification described earlier herein may be enhanced with an additional field called “flow-importance” that may signify relative priority among all the application flows in the service. In some embodiments, the priority information may be considered when a UE requests an update of QoS for a service without explicitly mentioning which application flow is to be QoS enhanced, for example as shown in FIG. 12.

FIG. 12 illustrates an example method 1200 for adjusting QoS/policy for a service using flow importance according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for adjusting QoS/policy for a service using flow importance could be used without departing from the scope of this disclosure.

In the example of FIG. 12, method 1200 begins at step 12-1. At step 12-1, ASP 402 provides service configuration 1206 to the AF 408. As part of the service configuration information included in service configuration 1206, ASP 402 provides content specification information and edge deployment information as described earlier herein. As part of the content specification information, for each of the application flows, the ASP 402 includes the QoS information, and also flow importance or priority information.

At step 12-2, AF 408 interacts with a PCF to provision QoS parameters for the user plane paths.

At step 12-3, the PCF interacts with other network control functions to provision the requested QoS on the user plane between the network and the UE 430.

At step 12-4, service content is ingested into the operator network 404 at an application server 1208 by the ASP 402 or an application content provider.

At step 12-5, the ingested content is distributed to the UE 430 using the provisioned media plane paths.

Some point later, at step 12-6, the UE 430 notices a drop off in performance, and requests an update for the QoS/policy of the service. The UE 430 may not indicate which of the application flows are to be QoS adjusted.

At step 12-7, AF 408 uses the priority information of different application flows to optimize the QoS for that application flow.

Although FIG. 12 illustrates one example method 1200 for adjusting QoS/policy for a service using flow importance, various changes may be made to FIG. 12. For example, while shown as a series of steps, various steps in FIG. 12 could overlap, occur in parallel, occur in a different order, occur any number of times, be omitted, or replaced by other steps.

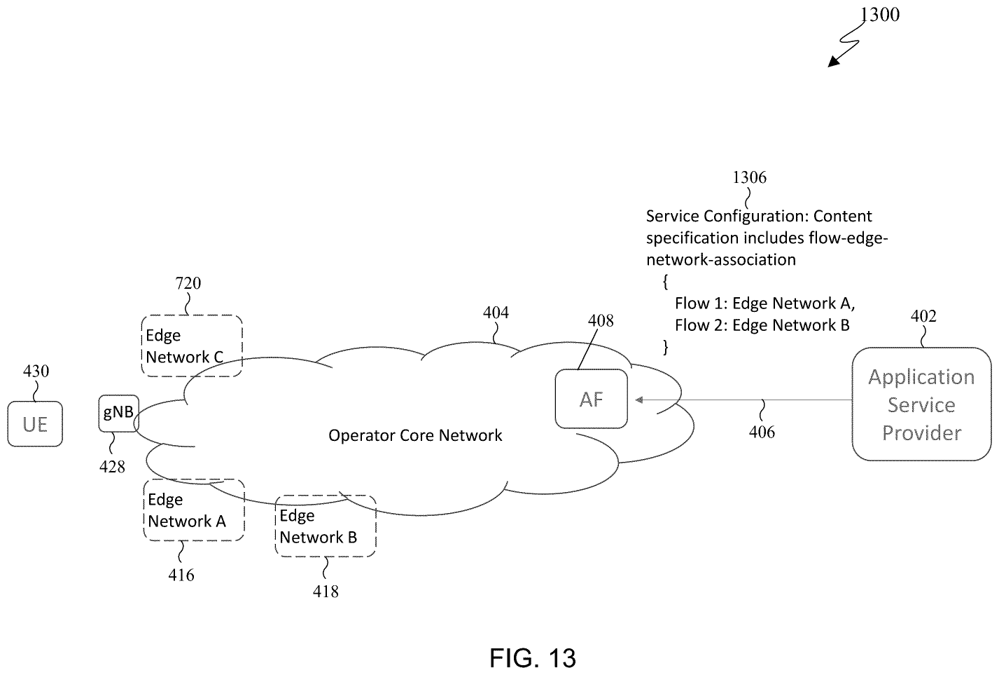

As discussed earlier herein, a method for indicating a prioritized list of edge networks in service configuration information from an application service provider to an application function in an operator network is described with respect to FIG. 7. However, the example of FIG. 7 describes a procedure for using the provisioned list of edge networks while performing the edge deployment of the application service. Various embodiments of the present disclosure provide for a procedure for using specific edge networks for specific application flows in the application service, for example as shown in FIG. 13.

FIG. 13 illustrates an example 1300 of ASP configuration of service parameters including application flow edge network association according to embodiments of the present disclosure. The embodiment of ASP configuration of service parameters of FIG. 1300 is for illustration only. Different embodiments of ASP configuration of service parameters including application flow edge network association could be used without departing from the scope of this disclosure.

As shown in FIG. 13, the ASP 402 may include a field called “flow-edge-network-association” for each application flow in service configuration information included in service configuration 1306 in addition to other content as previously described herein. The value of this field is set to be the preferred edge network where the processing of the application flow is to take place.

When the AF 408 receives the service configuration information with the content specification information, AF 408 checks to see whether the content specification for each application flow includes the “flow-edge-network-association” field. When the AF 408 determines that for an application flow, an association for a preferred edge network is provided using this field, the AF 408 interacts with other control functions (e.g., entities 410) to setup edge processing of that application flow in the given edge network.

Although FIG. 13 illustrates one example 1300 of ASP configuration of service parameters including application flow edge network association, various changes may be made to FIG. 13. For example, various changes to number of edge networks could be made, AF 408 could be replaced with a different network entity, etc. according to particular needs.

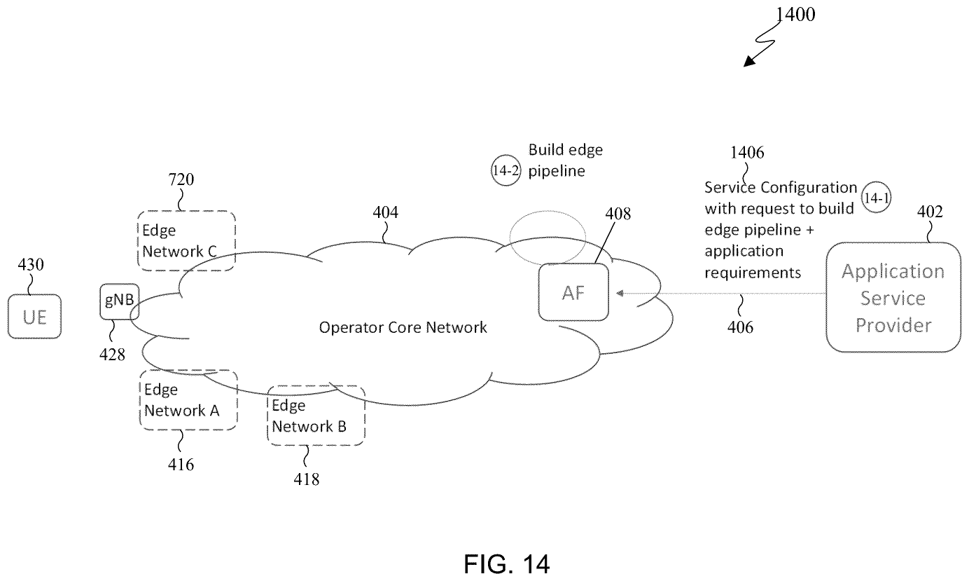

As discussed earlier herein, a method is described with respect to FIGS. 9 and 10A-10C where edge pipeline information is exchanged between an application server provider and application function in an operator network in which the network operator sets up edge application servers in requested edge networks. Various embodiments of the present disclosure provide for an alternative method, wherein the application server provider delegates the construction of edge pipelines to the application function, for example as shown in FIG. 14.

FIG. 14 illustrates an example method 1400 for edge pipeline construction according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for edge pipeline construction could be used without departing from the scope of this disclosure.

In the example of FIG. 14, method 1400 begins at step 14-1 At step 14-1, the ASP 402 provides a service configuration 1406 that includes a request for AF 408 to build an edge pipeline, and along with the request, includes detailed application requirements (e.g., QoS requirements of different application flows as described earlier herein).

At step 14-2, when the AF 408 receives the above request, AF 408 takes the responsibility of constructing the edge pipeline, and manages the edge pipeline as described herein.

Although FIG. 14 illustrates one example method 1400 for edge pipeline construction, various changes may be made to FIG. 14. For example, while shown as a series of steps, various steps in FIG. 14 could overlap, occur in parallel, occur in a different order, occur any number of times, be omitted, or replaced by other steps.

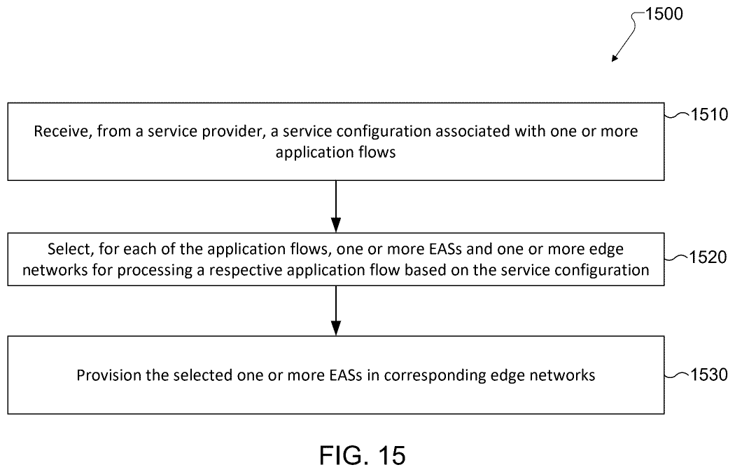

FIG. 15 illustrates an example method 1500 for provisioning EASs based on application flow requirements according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for provisioning EASs based on application flow requirements could be used without departing from the scope of this disclosure.

In the example of FIG. 15, method 1500 begins at step 1510. At step 1510, an apparatus (such as AF 408 of FIG. 8), receives, from a service provider (such as ASP 402 of FIG. 8), a service configuration associated with one or more application flows. In some embodiments, the service configuration may include, for each of the application flows, at least one of: (i) a content type, (ii), a QoS specification, (iii) a flow-importance, (iv) a PDU set indication, (v) a flow-edge-network-association, and (vi) a flow-edge-application-server-association.

At step 1520, the apparatus selects, for each of the application flows, one or more EASs and one or more edge networks for processing a respective application flow based on the service configuration.

At step 1530, the apparatus provisions the selected one or more EASs in corresponding edge networks.

In some embodiments, the apparatus may further determine whether at least one of a QoS falls below a QoS threshold or a QoE falls below a QoE threshold for an application flow, and in response to a determination that at least one of the QoS falls below the QoS threshold or the QoE falls below the QoE threshold for the application flow, reorganize an edge services deployment including EASs selected for the application flow. To reorganize the edge services deployment, the apparatus may further perform at least one of: (i) modifying a processing order; (ii) relocating an EAS, (iii) introducing an additional EAS, and (iv) updating a processing functionality of one or more edge application functions.

In some embodiments, for one or more of the application flows, the apparatus may further construct an edge pipeline associated with a respective application flow. In these embodiments, the edge application servers selected for the respective application flow may be provisioned in the corresponding edge networks based on the edge pipeline. The edge pipeline may include: (i) a set of nodes representing EASs, (ii) a set of associations between the nodes and edge networks, and (iii) a set of connections defining a processing sequence between the nodes. To construct the edge pipeline, the apparatus may further determine a sequence or parallel arrangement of EASs for distributed processing of the respective application flow. In some embodiments, the service configuration may include, for each of the application flows, a quality QoS requirement and an edge computing requirement, and the apparatus may construct the edge pipeline based on the QoS requirement and the edge computing requirement. In some embodiments, the apparatus may further determine whether at least one of a QoS falls below a QoS threshold or a QoE falls below a QoE threshold for the edge pipeline, and in response to a determination that at least one of the QoS falls below the QoS threshold or the QoE falls below the QoE threshold for the edge pipeline, the apparatus may further modify the edge pipeline. To modify the edge pipeline, the apparatus may further perform at least one of: (i) modifying a processing order, (ii) relocate an EAS, (iii) splitting a processing functionality, and (iv) introducing an additional EAS.

Although FIG. 15 illustrates one example method 1500 for provisioning EASs based on application flow requirements, various changes may be made to FIG. 15. For example, while shown as a series of steps, various steps in FIG. 15 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An apparatus comprising:
a transceiver configured to receive, from a service provider, a service configuration associated with one or more application flows; and
a processor operably coupled to the transceiver, the processor configured to:
select, for each of the application flows, one or more edge application servers (EASs) and one or more edge networks for processing a respective application flow based on the service configuration; and
provision the selected one or more EASs in corresponding edge networks.

2. The apparatus of claim 1, wherein the service configuration includes, for each of the application flows, at least one of:
a content type;
a quality of service (QoS) specification;
a flow-importance;
a protocol data unit (PDU) set indication;
a flow-edge-network-association; and
a flow-edge-application-server-association.

3. The apparatus of claim 1, wherein the processor is further configured to:
determine whether at least one of a QoS falls below a QoS threshold or a quality of experience (QoE) falls below a QoE threshold for an application flow; and
in response to a determination that at least one of the QoS falls below the QoS threshold or the QoE falls below the QoE threshold for the application flow, reorganize an edge services deployment including EASs selected for the application flow.

4. The apparatus of claim 3, wherein to reorganize the edge services deployment, the processor is further configured to at least one of:
modify a processing order;
relocate an EAS;
introduce an additional EAS; and
update a processing functionality of one or more edge application functions.

5. The apparatus of claim 1, wherein:
the service configuration includes priority information for each of the application flows;
the transceiver is further configured to receive, from a user equipment (UE), a quality of service (QoS) update request for an application; and
the processor is further configured to, based on the QoS update request and the priority information, optimize a QoS for an application flow corresponding to the application.

6. The apparatus of claim 1, wherein:
the processor is further configured to, for one or more of the application flows, construct an edge pipeline associated with a respective application flow; and
the edge application servers selected for the respective application flow are provisioned in the corresponding edge networks based on the edge pipeline.

7. The apparatus of claim 6, wherein:
the edge pipeline includes:
a set of nodes representing EASs;
a set of associations between the nodes and edge networks; and
a set of connections defining a processing sequence between the nodes, and
to construct the edge pipeline, the processor is further configured to determine a sequence or parallel arrangement of EASs for distributed processing of the respective application flow.

8. The apparatus of claim 6, wherein:
the service configuration includes, for each of the application flows, a quality of service (QoS) requirement and an edge computing requirement; and
the processor is further configured to construct the edge pipeline based on the QoS requirement and the edge computing requirement.

9. The apparatus of claim 6, wherein the processor is further configured to:
determine whether at least one of a QoS falls below a QoS threshold or a quality of experience (QoE) falls below a QoE threshold for the edge pipeline; and
in response to a determination that at least one of the QoS falls below the QoS threshold or the QoE falls below the QoE threshold for the edge pipeline, modify the edge pipeline.

10. The apparatus of claim 9, wherein to modify the edge pipeline, the processor is further configured to at least one of:
modify a processing order;
relocate an EAS;
split a processing functionality; and
introduce an additional EAS.

11. A method of operating an apparatus, the method comprising:
receiving, from a service provider, a service configuration associated with one or more application flows;
selecting, for each of the application flows, one or more edge application servers (EASs) and one or more edge networks for processing a respective application flow based on the service configuration; and
provisioning the selected one or more EASs in corresponding edge networks.

12. The method of claim 11, wherein the service configuration includes, for each of the application flows, at least one of:
a content type;
a quality of service (QoS) specification;
a flow-importance;
a protocol data unit (PDU) set indication;
a flow-edge-network-association; and
a flow-edge-application-server-association.

13. The method of claim 11, further comprising:
determining whether at least one of a QoS falls below a QoS threshold or a quality of experience (QoE) falls below a QoE threshold for an application flow; and
in response to a determination that at least one of the QoS falls below the QoS threshold or the QoE falls below the QoE threshold for the application flow, reorganizing an edge services deployment including EASs selected for the application flow.

14. The method of claim 13, wherein to reorganize the edge services deployment, the method further comprises at least one of:
modifying a processing order;
relocating an EAS;
introducing an additional EAS; and
updating a processing functionality of one or more edge application functions.

15. The method of claim 11, wherein:
the service configuration includes priority information for each of the application flows; and
the method further comprises:
receiving, from a user equipment (UE), a quality of service (QoS) update request for an application; and
based on the QoS update request and the priority information, optimizing a QoS for an application flow corresponding to the application.

16. The method of claim 11, wherein:
the service information includes, for one or more of the application flows, an edge pipeline associated with a respective application flow; and
edge application servers selected for the respective application flows are provisioned in the corresponding edge networks based on the associated edge pipeline.

17. The method of claim 16, wherein:
the edge pipeline includes:
a set of nodes representing EASs;
a set of associations between the nodes and edge networks; and
a set of connections defining a processing sequence between the nodes, and
to construct the edge pipeline, the method further comprises determining a sequence or parallel arrangement of EASs for distributed processing of the respective application flow.

18. The method of claim 16, wherein:
the service configuration includes, for each of the application flows, a quality of service (QoS) requirement and an edge computing requirement; and
the edge pipeline is constructed based on the QoS requirement and the edge computing requirement.

19. The method of claim 16, further comprising:
determining whether at least one of a QoS falls below a QoS threshold or a quality of experience (QoE) falls below a QoE threshold for the edge pipeline; and
in response to a determination that at least one of the QoS falls below the QoS threshold or the QoE falls below the QoE threshold for the edge pipeline, modifying the edge pipeline.

20. The method of claim 19, wherein to modify the edge pipeline, the method further comprises at least one of:
modifying a processing order;
relocating an EAS;
splitting a processing functionality; and
introducing an additional EAS.
